(19) United States
(12) Patent Application Publication
(10) Pub. No.: US 2018/0141312 A1
(43) Pub. Date: May 24, 2018

(54) COMPOSITE MATERIAL STRUCTURE

(71) Applicant: TYKO TECH. CO., LTD, New Taipei City (TW)

(72) Inventors: CHIH-HSIAO CHIEN, New Taipei City (TW); CHING-CHUN LIN, New Taipei City (TW)

(73) Assignee: TYKO TECH. CO., LTD, New Taipei City (TW)

(21) Appl. No.: 15/709,473

(22) Filed: Sep. 20, 2017

(30) Foreign Application Priority Data
Nov. 22, 2016 (TW) 105217844

(51) Int. Cl. B32B 15/092

(52) U.S. Cl. CPC B32B 15/092; B32B 2260/021; B32B 2260/046; B32B 2250/42

(57) ABSTRACT

A composite material structure provided with a prepreg structure unit with metallic properties, the prepreg structure unit comprising a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer, so as to strengthen the overall structural strength to reduce structural damages during mechanical processes which may cause fractured fibers, and to prevent strain arisen from the difference of coefficient of thermal expansion of different materials subject to changes in the surrounding temperature, from loosening or dissociating between the different materials, and beneficial to produce a qualified metallic appearance for a finished product made thereof.

### BACKGROUND OF THE INVENTION

### 1. Field of the Invention

The present invention relates to a composite material structure, and particularly to a composite material structure capable of reducing structural damages during mechanical processes in need of drilling or rivet jointing, which may cause fractured fibers around a thwack spot, and to prevent strain arisen from the difference of coefficient of thermal expansion of different materials subject to changes in the surrounding temperature, from loosening or dissociating between the different materials, and beneficial to produce a qualified metallic appearance for a finished product made thereof.

### 2. Related Art

As well known, a composite material (also called a composition material or shortened to composite which is the common name) is a material made from two or more constituent materials, such as metallic materials, carbon fiber materials or glass fiber materials, with significantly different physical or chemical properties that, when combined, produce a structure with characteristics different from the individual components. The individual components remain separate and distinct within a finished structure. The combined material structure may be preferred for many applications.

Conventionally, the composite material is of a fiber metal laminate (FML) which is one of a class of metallic materials consisting of a laminate of metal layers bonded with layers of fiber-reinforced composite material such as a carbon fiber composite, a graphite fiber composite, a glass fiber composite, or an aramid fiber composite. This allows the material to behave much as a fibrous prepreg, but with considerable specific advantages regarding metallic properties such as impact resistance, high mechanical toughness and bending stiffness as well as corrosion resistance, heat isolation, sound absorption, vibration reduction, extremely low or high temperature resistance, etc.

The composite material has been popularly applied in a variety of fields such as aviations, vehicles, exercise machines, electronic products and architecture. Although the material has preferable physical and chemical properties, an overall structure thereof such as prepreg with metallic properties has found only limited application and is not suitable for all possible uses or purposes in the variety of fields. As shown in FIG. 1, a prepreg structure unit 5 consists of a laminate of a fiber-reinforced composite layer 51 composed of plural fibrous sheets stacked or laminated one on top of another, and bonded with a metal layer 52 having a required thickness to provide mechanical strength and toughness, as a conventional FML prepreg structure unit. In forming processing steps, several prepreg structure units 5 are stacked on top of each other, and provide metallic properties advantageous for following mechanical processes such as drilling, rivet jointing, screws jointing, welding, etc. In spite of an excellent planar tensile strength that the prepreg structure unit 5 can provide by means of the fiber-reinforced composite layer 51 configured in planar multiple directions, but the tolerance of the prepreg structure unit 5 in an axial direction against drilling, rivet jointing, screws jointing or welding in mechanical processes is not sufficient. Once a rivet or a screw is thwacked into the prepreg structure unit 5, fibers around a thwack spot within the fiber-reinforced composite layer 51 may be fractured irregularly, which may cause irreversible structural damages and may weaken the overall structural strength of the prepreg structure.

In another aspect, the connection of the fiber-reinforced composite layer 51 and the metal layer 52 is subject to the changes to the surrounding temperature. The fiber-reinforced composite layer 51 and the metal layer 52 as different materials differ in the coefficient of thermal expansion so that when the surrounding temperature changes, strain may arise and cause looseness or dissociation therebetween, resulting in irreversible structural damages and weakening the overall structural strength of the prepreg structure.

In this regard, the present inventor has found that with the same thickness as the prepreg structure unit 5 consisting of a laminate of the plural fibrous sheets of the fiber-reinforced composite layer 51 bonded with the metal layer 52, the metal layer 52 may be further divided into several metallic sheets to be alternatively laminated with the plural fibrous sheets of the fiber-reinforced composite layer 51 so that the overall structural strength and toughness of the prepreg can be further enhanced and quality of finished products made thereof can be optimized.

### SUMMARY OF THE INVENTION

It is an object of the present invention to provide a composite material structure with metallic properties, which is improved to avoid structural damages during mechanical processes in need of drilling, rivet jointing, screws jointing, welding, etc., which may cause fractured fibers around a thwack spot and to prevent strain arisen from the difference of coefficient of thermal expansion of different materials subject to changes in the surrounding temperature, from loosening or dissociating between the different materials, which may cause the structural damages as well, and the composite material structure is beneficial to provide a qualified metallic appearance for a finished product made thereof.

To attain this, the composite material structure is provided with a prepreg structure unit with metallic properties. The prepreg structure unit comprises a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer.

### BRIEF DESCRIPTION OF THE DRAWINGS

FIG. 1 is a perspective view showing a conventional prepreg structure unit consisting of a laminate of two different materials;

FIG. 2 is a perspective view showing a prepreg structure unit consisting of a laminate of two different materials in accordance with a first embodiment of the present invention;

FIG. 3 is a schematic view showing the prepreg structure unit consisting of a laminate of two different materials in accordance with the first embodiment of the present invention;

FIGS. 4A and 4B are schematic views showing a comparison of the conventional prepreg structure unit and prepreg structure unit of the present invention during a mechanical process in need of drilling;

FIG. 5 is a schematic view showing a prepreg structure unit in accordance with a second embodiment of the present invention.

### DESCRIPTION OF THE INVENTION

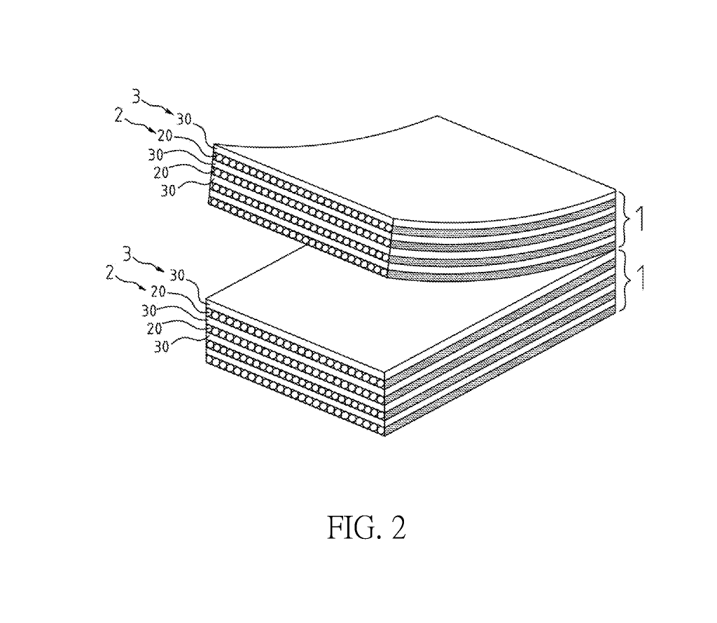

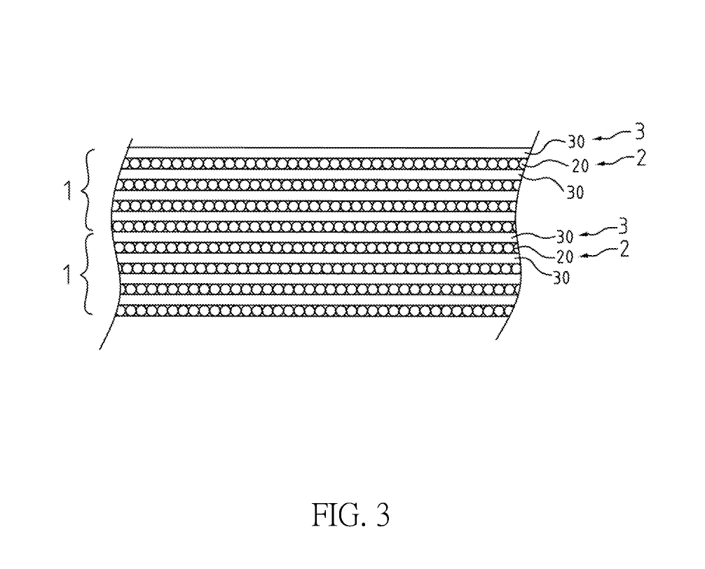

Referring to FIGS. 2 and 3, which show a first embodiment of a composite material structure in accordance with the present invention, and in particular to FIG. 2 where a composite material structure is provided with a prepreg structure unit 1 with metallic properties comprising a fiber-reinforced composite layer 2 and a metal layer 3. The fiber-reinforced composite layer 2 is composed of plural fibrous sheets 20 each selected from the group consisting of carbon fiber, glass fiber and aromatic polyamide fiber. Each of the fibrous sheets 20 of the fiber-reinforced composite layer 2 is impregnated with an epoxy for viscosity to the metal layer 3. The epoxy is selected from the group consisting of thermosetting resin or thermoplastics. The metal layer 3 is composed of plural metallic sheets 30 each selected from the group consisting of titanium, titanium alloy, copper, steel, aluminium, aluminium alloy and magnesium-aluminum alloy. A constituent material of each of the plural metallic sheets 30 is same.

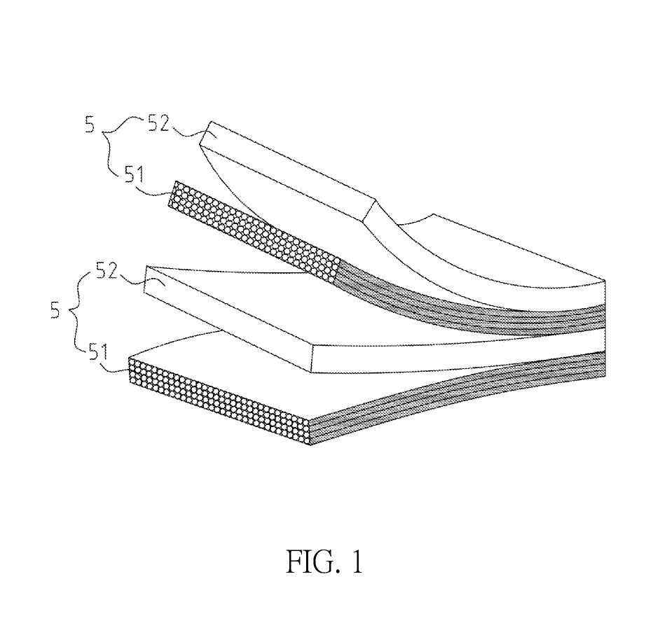

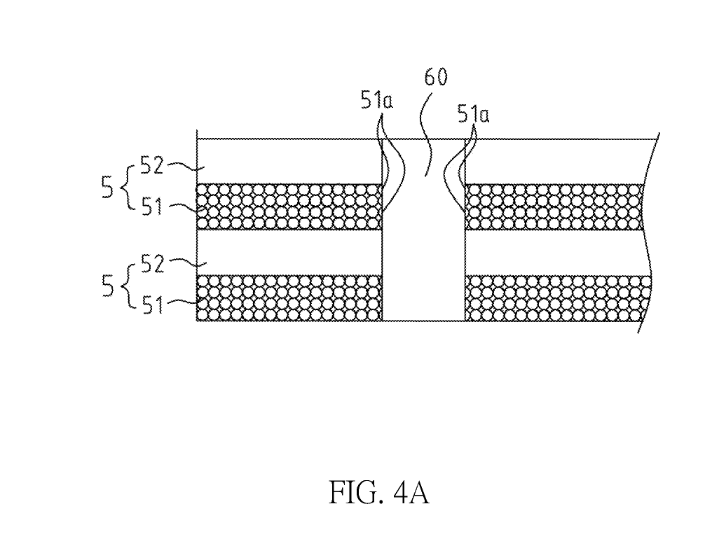

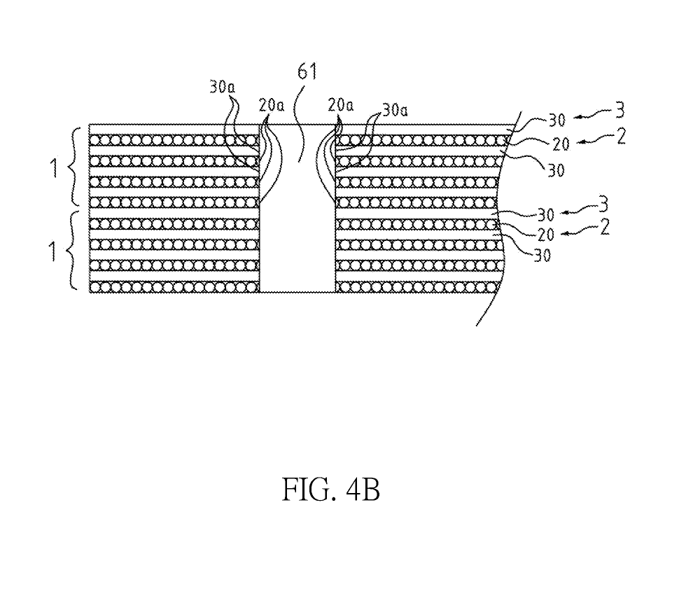

By comparison with the conventional prepreg structure unit 5 consisting of the laminate of the plural fibrous sheets of the fiber-reinforced composite layer 51 bonded with the single metal layer 52 (FIG. 1), the prepreg structure unit 1 in accordance with the present invention consists of an alternative laminate of the plural fibrous sheets 20 of the fiber-reinforced composite layer 2 and the plural metallic sheets 30 of the metal layer 3 with the same thickness as the conventional prepreg structure unit 5. In so structure, i.e. the alternative laminate of the plural fibrous sheets 20 and the metallic sheets 30 (FIG. 4B), provided in the present invention with more and thinner layers with a same thickness, strain arisen from the difference of coefficient of thermal expansion of different materials subject to the changes in the surrounding temperature may be reduced, so that the looseness or dissociation between the different materials can be avoided and the overall structural strength of the composite material provided with the prepreg structure unit 1 in accordance with the present invention can be enhanced.

With reference to FIG. 4A and FIG. 4B, structures of two stacked layers for the conventional prepreg structure unit 5 and for the prepreg structure unit 1 of the present invention during a mechanical process in need of drilling are respectively shown. In comparison of FIG. 4A and FIG. 4B, although it is shown in FIG. 4A that the conventional prepreg structure unit 5 is composed of the laminate of the plural fibrous sheets of the fiber-reinforced composite layer 51 and the single metal layer 52, it is difficult to withstand the pressure of an inserting screw 60 such as a self-drilling screw or a rivet from the axial direction during mechanical processes in need of drilling, rivet jointing, screws jointing, welding, etc., which may cause irregularly fractured fibers around a thwack spot 51a within the fiber-reinforced composite layer 51 as an irreversible structural damage which may weaken the overall structural strength of the prepreg structure unit 5. In contradistinction, with the same thickness as the conventional prepreg structure unit 5, the prepreg structure unit 1 in accordance with the present invention consists of an alternative laminate of the plural fibrous sheets 20 of the fiber-reinforced composite layer 2 and the plural metallic sheets 30 of the metal layer 3 wherein each of the plural fibrous sheets 20 is strengthened by adjacent metallic sheets 30, so as to enhance the overall structural strength of the prepreg structure unit 1. During the mechanical process in need of drilling, rivet jointing, screws jointing or welding, fibers around a thwack spot 20a of each fibrous sheets 20 can be held up by adjacent thwack spots 30a of the isotropic metallic sheets 30 as a sandwich structure capable of equally distributing the pressure brought by an inserting screw 61 piercing in an axial direction, so as to reduce the undesirable influence on binding strength between layers or the overall structural strength. This solves the problem arisen by the conventional prepreg 5 that fractured fibers around the thwack spot of the fiber-reinforced composite layer 51 appear during mechanical processes in need of drilling, rivet jointing, screws jointing, welding, etc. Thus, the overall structural strength of the composite material structure in accordance with the present invention is improved.

In manufacturing, the composite material structure in accordance with the present invention can be made in a large size as a roll of prepreg or in a small size as a towpreg similar to a tape, in order to meet customer requirement.

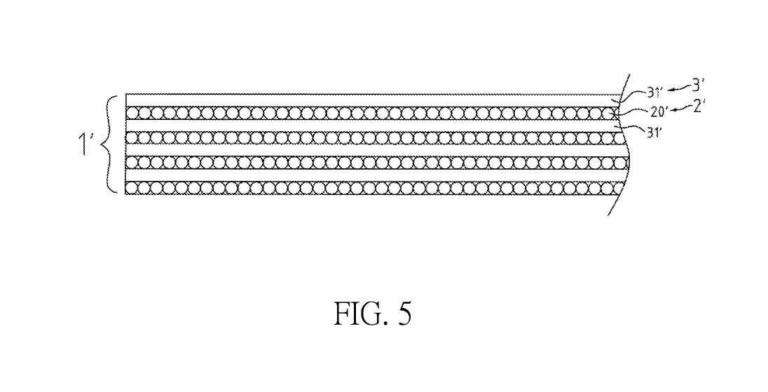

With reference to FIG. 5, which shows a second embodiment in accordance with the present invention, a prepreg structure unit 1′ consisting of an alternative laminate of plural fibrous sheets 20′ of a fiber-reinforced composite layer 2′ and plural metallic sheets 31′ of a metal layer 3′ in this embodiment is obtained in the same manner as the prepreg structure unit 1 consisting of the alternative laminate of the plural fibrous sheets 20 of the fiber-reinforced composite layer 2 and the plural metallic sheets 30 of the metal layer 3 in the first embodiment, except that the metal layer 3′ in this embodiment including multiple metallic materials. That is, each metallic sheet 31′ of the metal layer 3 is made of different metallic material, so that the overall structural strength of the composite material may be further enhanced. Different metallic materials would produce different metallic properties, so the metallic materials could be selected according to the required prepreg strength for different products. Compared with the conventional prepreg structure unit 5 consisting of the laminate of the plural fibrous sheets of the fiber-reinforced composite layer 51 and the single metal layer 52, the prepreg structure unit 1′ is also capable of reducing strain arisen from the difference of coefficient of thermal expansion of two different materials such as the fibrous sheets 20′ and metallic sheets 31′ subject to the changes in the surrounding temperature, so as to enhance the overall structural strength of the composite material. This is also beneficial to proceeding mechanical processes in need of drilling, rivet jointing, screws jointing, welding.

As described in the first and second embodiments in accordance with the present invention wherein the composite material structure is provided with an alternative laminate of the plural fibrous sheets 20,20′ of the fiber-reinforced composite layer 2,2′ and the plural metallic sheets 30,31′ of the metal layer 3,3′. When the metallic sheets 30,31′ of the metal layer 3,3′ are assigned to surface layers of the prepreg structure unit 1,1′ or surfaces of a finished product made thereof, it is beneficial to proceed with a surface treating process such as the sand blasting, anodization, bright finishing, coating and hair-line surface treatment to produce a qualified metallic appearance, which is hard to be achieved by traditional technology such as painting or baking painting.

It is understood that the invention may be embodied in other forms within the scope of the claims. Thus the present examples and embodiments are to be considered in all respects as illustrative, and not restrictive, of the invention defined by the claims.

What is claimed is:

1. A composite material structure provided with a prepreg structure unit with metallic properties, the prepreg structure unit comprising a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer, wherein a constituent material for each of the plural metallic sheets is same.

2. The composite material structure of claim 1, wherein each of the plural fibrous sheets is selected from a group consisting of carbon fiber, glass fiber and aromatic polyamide fiber, and the selected fibrous sheets include different levels of tensile strength and tensile module.

3. The composite material structure of claim 1, wherein each of the plural metallic sheets is selected from a group consisting of titanium, titanium alloy, copper, steel, aluminium, aluminium alloy and magnesium-aluminum alloy.

4. The composite material structure of claim 1, wherein each of the fibrous sheets is impregnated with an epoxy selected from a group consisting of thermosetting resin or thermoplastics.

5. A composite material structure provided with a prepreg structure unit with metallic properties, the prepreg structure unit comprising a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer, wherein a constituent material for each of the plural metallic sheets is same, and wherein when assigned to surface layers of the prepreg structure unit, the plural metallic sheets are beneficial to proceed with a surface treating process to produce a qualified metallic appearance.

6. A composite material structure provided with a prepreg structure unit with metallic properties, the prepreg structure unit comprising a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer, wherein a constituent material for each of the plural metallic sheets is different.

7. The composite material structure of claim 6, wherein each of the plural fibrous sheets is selected from a group consisting of carbon fiber, glass fiber and aromatic polyamide fiber, and the selected fibrous sheets include different levels of tensile strength and tensile module.

8. The composite material structure of claim 6, wherein each of the plural metallic sheets is selected from a group consisting of titanium, titanium alloy, copper, steel, aluminium, aluminium alloy and magnesium-aluminum alloy.

9. The composite material structure of claim 6, wherein each of the fibrous sheets is impregnated with an epoxy selected from a group consisting of thermosetting resin or thermoplastics.

10. A composite material structure provided with a prepreg structure unit with metallic properties, the prepreg structure unit comprising a fiber-reinforced composite layer composed of plural fibrous sheets, and a metal layer composed of plural metallic sheets, wherein the plural fibrous sheets are alternatively laminated with the plural metallic sheets with the same thickness as a conventional prepreg structure unit merely consisting of a laminate of the plural fibrous sheets bonded with a single metal layer, wherein a constituent material for each of the plural metallic sheets is different, and wherein when assigned to surface layers of the prepreg structure unit, the plural metallic sheets are beneficial to proceed with a surface treating process to produce a qualified metallic appearance.
